(19) United States
(12) Patent Application Publication
(10) Pub. No.: US 2007/0154604 A1
(43) Pub. Date: Jul. 5, 2007

(54) Device and method for forming an elongated dough portion

(76) Inventor: Lothar Pasch, Terborg (NL)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/585,598

(22) PCT Filed: Jan. 21, 2005
(86) PCT No.: PCT/NL05/00046

§ 371 Date: Jan. 17, 2007

(30) Foreign Application Priority Data
Jan. 23, 2004 (NL) 1025311

(51) Int. Cl. A21D 6/00

(52) U.S. Cl. 426/496

(57) ABSTRACT

Device (1) for transforming a dough ball (K, K1, K2) into an elongated dough portion (P, P1, P2), comprising a supply (2) for the dough ball (K), a roller assembly (7, 8) receiving the dough ball (Kl, K2) from the supply (2) for rolling the dough ball (K1, K2) into a flat piece of dough (P, P1,P2), and means (14, 15) for rolling up the flat piece of dough (P, P1, P2) into an elongated roll of dough (R), wherein the supply (2) is adapted for joint discharge of at least two adjacent dough balls (K1, K2) to the roller assembly (7, 8).

The invention relates to a device and method for forming an elongated dough portion.

It is known to form elongated dough portions out of dough balls and to use them for baking bread. For long breads use is made to that end of a transformation device into which dough balls are fed one after the other and are flattened between a roller assembly of a so-called moulder, are subsequently rolled up into dough rolls, and the dough rolls are stretched by a number of successive rolling motions. Between the successive rolling motions, periods of rest are often provided in order to bring the dough back into a stressless condition as much as possible, this in order to enhance the quality and the procesability of the dough.

Due to the successive treatment stations and the periods of rest such a device is bulky and therefore costly.

It is an object of the invention to improve on this or to provide an alternative.

From one aspect the invention to that end provides a device for transforming a dough ball into an elongated dough portion, comprising a supply for the dough ball, a roller assembly receiving the dough ball from the supply for rolling the dough ball into a flat piece of dough, and means for rolling up the flat piece of dough into an elongated roll of dough, wherein the supply is adapted for. joint discharge of at least two adjacent dough balls to the roller assembly. Starting from an unchanged dough ball size an increased quantity of dough—considered in transverse direction—can be fed into the roller assembly, as a result of which from the start a much broader slab of dough can easily be obtained, which is subsequently rolled up and can easily be lengthened into the desired longitudinal size. Thus follow-up treatments and the periods of rest they entail can be cut. The device can be kept compact and cheap.

Preferably the supply and the roller assembly are adapted in mutual adjustment for feeding and flattening adjacent dough balls while forming a transitional area in between them, considered in a direction transverse to the process direction. The dough of the adjacent dough balls thus merges smoothly, avoiding discontinuities.

In an embodiment that is easy to build up as regards structure, the supply is provided with a feed for consecutively supplied dough balls and with a distributor and buffer for transforming a succession of dough balls supplied in series into a succession of dough balls discharged parallel to the roller assembly.

In a simple, compact and cheap embodiment the supply is adapted for simultaneously discharging two dough balls.

In a manner known per se the device may furthermore comprise a roll-out unit placed after the roll-up means, for lengthening the roll of dough. Said roll-out unit is able to lengthen the dough roll that is relatively long already, in the usual manner into an integral, relatively long final product, that may particularly be used for baking baguettes.

Preferably at least two dough balls are supplied adjacent to each other to a roller assembly, are passed therethrough and are flattened thereby, wherein during flattening, the dough of dough balls that are adjacent to each other in a direction transverse to the process direction is urged into close contact with each other.

From a further aspect the invention provides a method for transforming a dough ball into an elongated dough portion, wherein at least two dough balls are supplied adjacent to each other to a roller assembly, are passed therethrough and are flattened thereby, wherein during flattening, the dough of dough balls that are adjacent to each other in a direction transverse to the process direction are formed into a slab of dough forming one unity.

In a possible embodiment the dough balls are supplied with a mutual distance that is larger than the size of the dough balls in a direction transverse to the process direction.

Preferably a number of dough balls are supplied successively, the dough balls are positioned adjacent to each other and they are simultaneously discharged to a roller assembly and are flattened parallel therein.

Preferably the dough after flattening is rolled up into a dough roll, which subsequently is preferably passed through a device for lengthening the dough roll by rolling.

In a possible embodiment dough balls having a diameter of approximately 7-10 cm are supplied. The rollers may transform the dough balls into a slab having a thickness of approximately 1.5-2.5 cm.

The rollers may for instance transform two dough balls simultaneously into a slab of dough having a width of approximately 40-50 cm. The dough roll resulting from said slab can easily be lengthened into a length of at least 75 cm.

Preferably the lengthened dough roll is used for forming a so-called Zopfbrot or Brioche, or for baguettes.

In one embodiment of the method according to the invention use is made of dough balls of wheat flour or a wheat-containing mixture.

The invention will be elucidated on the basis of an exemplary embodiment shown in the attached drawings, in which:

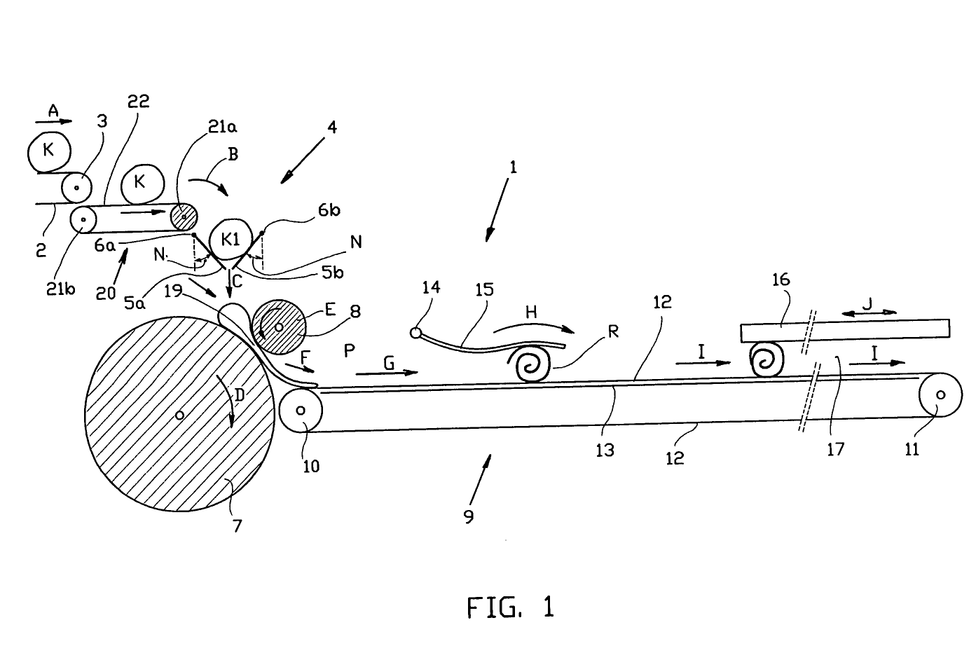

FIG. 1 shows a schematic side view of a part of an exemplary embodiment of a device according to the invention; and

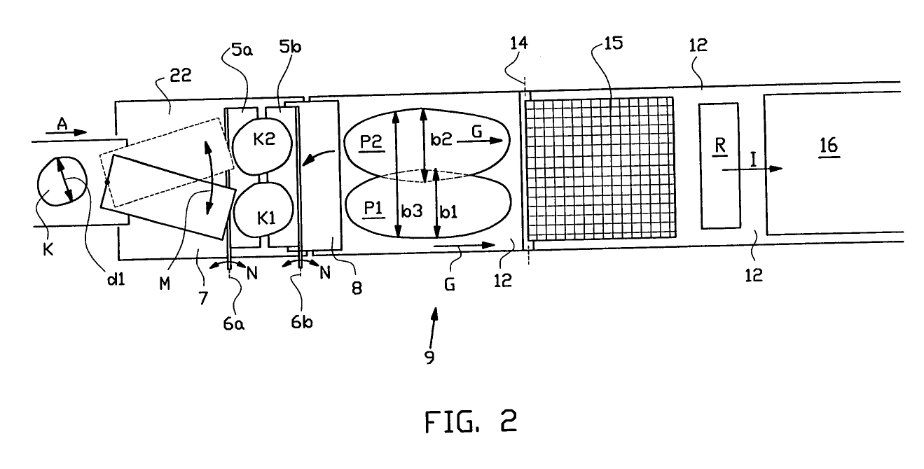

FIG. 2 shows a top view of the device according to FIG. 1.

The moulder/device 1 shown in FIGS. 1 and 2 comprises a supply for dough balls K from the direction A. In this example the supply device comprises a conveyor belt 2 circulating about rollers, of which one turning roller 3 is shown.

Above the downstream roller 3 for the conveyor belt 2 a distributor 20 is placed, comprising a conveyor belt 22 circulating about roller 21a and driven roller 21b, which conveyor belt is turnable in the direction M (FIG. 2) about a vertical axis 23 between both shown positions.

Directly below the downstream end of the distributor 20 there is a buffer 4, having valve bottoms 5a,b, on which, as can be seen in FIG. 2, two dough balls K1, K2 can be supported adjacent to each other. The valves 5a,b are rotatable in the directions N about axes 6a,b.

Below the buffer 4 a roller pair 7, 8 is positioned, consisting of a large pressure roller 7 that is driven in the direction D, and a small counter roller 8 driven in the direction E. With means that are not further shown the mutual distance of the rollers 7 and 8 can be set, in order to set the size of the passage 19.

Downstream of the roller pair 7, 8 there is a further conveyor 9, having a conveyor belt 12 circulating about rollers 10, 11, at least one of which is driven. The upper path of the conveyor belt 12 is supported by a stationary plate 13.

Downstream of the upstream turning roller 10 a fine-meshed metal net 15 is attached to a stationary rod 14.

At some distance downstream thereof, a roll-out board 16 is placed above the conveyor belt 12, which board 16 may optionally be reciprocally moved in the directions J, and which defines a passage 17 with conveyor belt 12, which passage in one embodiment may taper in downstream direction.

When the device of FIGS. 1 and 2 is operative, dough balls K are supplied in the direction A. The dough ball may have a diameter D1 of for instance 80 mm.

For orienting the dough balls K in the transition (B) to the buffer 4 the distributor 22 is placed in an inclined position for orienting the leading dough ball K1 of a pair of dough balls K supplied consecutively on the conveyor belt 2 to the right-hand half of the buffer 4, and discharging (B) it thereto, and is subsequently rotated in the direction M into an opposite inclined position in order to bring the next dough ball K2 to the left-hand side of the buffer 4. Other distribution means may be provided, for instance in the form of a conveyor 2, 3 that is reciprocally movable in transverse direction.

After two dough balls K1 and K2 are supported on the for instance Teflon-coated valves 5a,b of the buffer 4, the valves 5a,b are quickly turned open in the directions N, as a result of which the dough balls K1 and K2 will simultaneously, in a guided manner, fall in the direction C, in order to be simultaneously caught by both rollers 7 and 8.

The dough balls K1 and K2 will simultaneously be passed through the slit 19 formed by and in between the rollers 7 and 8, while flattening the dough into one slab P.

As can be seen in FIG. 2 the slab P may be geometrically built up from two more or less elliptic areas P1 and P2, having a short axis or width b1, b2 of for instance 25 cm. Due to the geometrical overlap the overall width b3 is slightly smaller than b1 and b2, for instance 45 cm. It is clear, however, that the width b3 is much larger than either the width b1 or b2, and that a slab P formed as one unity has been formed. The thickness may be approximately 1.5-2.5 cm, depending on the dough composition.

The slab P is passed further in the direction G, in order to, in a manner known per se, be rolled up in the direction H into an elongated roll of dough R when passing underneath the net 15. Said dough roll R is fed into the passage 17 in the direction I between the conveyor belt 12 and roll-out board 16. At that location the dough roll is rolled out in order to obtain a larger length, for instance a length of 80 cm.

The result then is that starting from two dough balls of 7-9 cm one long dough roll of 80 cm has been obtained, which may for instance be processed into the so-called Zopf loaves, in which the dough roll is as it were braided into itself. Alternatively a long baguette is thus easily obtained.

1. Device for transforming a dough ball into an elongated dough portion, comprising a supply for the dough ball, a roller assembly receiving the dough ball from the supply for rolling the dough ball into a separate flat piece of dough, and means for rolling up the flat piece of dough into an elongated roll of dough, wherein the supply is adapted for joint discharge of at least two adjacent dough balls to the roller assembly for forming said flat piece of dough.

2. Device according to claim 1, wherein the supply and the roller assembly are adapted in mutual adjustment for feeding and flattening adjacent dough balls while forming a transitional area in between them, considered in a direction transverse to the process direction.

3. Device according to claim 1, wherein the supply is provided with a feed for consecutively supplied dough balls and with a distributor and buffer for transforming a succession of dough balls supplied in series into a succession of dough balls discharged parallel to the roller assembly.

4. Device according to claim 1, wherein the supply is adapted for simultaneously discharging two dough balls.

5. Device according claim 1, comprising a roll-out or moulding unit placed after the roll-up means, for lengthening the roll of dough.

6. Method for transforming a dough ball into an elongated dough portion, wherein at least two dough balls are supplied adjacent to each other to a roller assembly, are passed therethrough and are flattened thereby in order to form a separate flat piece of dough, wherein during flattening, the dough of dough balls that are adjacent to each other in a direction transverse to the process direction is urged into close contact with each other.

7. Method for transforming a dough ball into an elongated dough portion, wherein at least two dough balls are supplied adjacent to each other to a roller assembly, are passed therethrough and are flattened thereby, wherein during flattening, the dough of dough balls that are adjacent to each other in a direction transverse to the process direction are formed into a separate slab of dough forming one unity.

8. Method according to claim 6, wherein the dough balls are supplied with a mutual distance that is larger than the size of the dough balls in a direction transverse to the process direction.

9. Method according to claim 6, wherein a number of dough balls are supplied successively, are positioned adjacent to each other and are simultaneously discharged to a roller assembly and are flattened parallel therein.

10. Method according claim 6, wherein to the dough after flattening is rolled up into a dough roll.

11. Method according to claim 10, wherein the dough roll is passed through a device for lengthening the dough roll by rolling.

12. Method according to claim 6, wherein dough balls having a diameter of approximately 7-9 cm are supplied.

13. Method according to claim 12, wherein the rollers transform dough balls into a slab having a thickness of approximately 1.5-2.5 cm.

14. Method according to claim 12, wherein the rollers transform two dough balls simultaneously into a slab of dough having a width of approximately 40-50 cm.

15. Method according to claim 11, wherein the dough roll is lengthened to a length of at least 75 cm.

16. Method according to claim 11, wherein the lengthened dough roll is used for forming a so-called Zopfbrot or Brioche, baguette.

17. Method according to claim 6, wherein use is made of dough balls of wheat flour or a wheat-containing mixture.

18-19. (canceled)

20. Method according to claim 7, wherein the dough balls are supplied with a mutual distance that is larger than the size of the dough balls in a direction transverse to the process direction.

21. Method according to claim 7, wherein a number of dough balls are supplied successively, are positioned adjacent to each other and are simultaneously discharged to a roller assembly and are flattened parallel therein.

22. Method according to claim 7, wherein the dough after flattening is rolled up into a dough roll.

23. Method according to claim 7, wherein the dough roll is passed through a device for lengthening the dough roll by rolling.

24. Method according to claim 7, wherein dough balls having a diameter of approximately 7-9 cm are supplied.
